(19) United States
(12) Patent Application Publication
(10) Pub. No.: US 2019/0157031 A1
(43) Pub. Date: May 23, 2019

(54) PROTECTION DEVICE AND CIRCUIT PROTECTION APPARATUS CONTAINING THE SAME

(71) Applicant: Polytronics Technology Corp., Hsinchu (TW)

(72) Inventors: Tsungmin SU, Hsinchu City (TW); Tongcheng TSAI, TAINAN CITY (TW); David Shau Chew WANG, TAIPEI CITY (TW)

(21) Appl. No.: 15/819,945

(22) Filed: Nov. 21, 2017

(51) Int. Cl. H01H 83/20; H01H 83/10; H01H 83/12

(52) U.S. Cl. CPC H01H 83/20; H01H 2209/002; H01H 83/12; H01H 83/10

(57) ABSTRACT

A protection device comprises a substrate, a fusible element and a heating element. The substrate has a surface provided with a first electrode and a second electrode. The fusible element comprises a first metal layer and a second metal layer disposed on the first metal layer. The melting temperature of the second metal layer is higher than that of the first metal layer. The fusible element connects to the first and second electrodes through solder. The solder has a melting temperature lower than that of the first metal layer. The heating element heats up to blow the fusible element in the event of over-voltage or over-temperature.

### BACKGROUND OF THE INVENTION

### (1) Field of the Invention

The present application relates to a protection device applied to an electronic apparatus and a circuit protection apparatus containing the same. More specifically, it relates to a protection device and a circuit protection apparatus capable of preventing over-voltage, over-current and/or over-temperature.

### (2) Description of the Related Art

Fuses containing low-melting metals, e.g., lead, tin, silver, bismuth, and copper, are well-known protection devices to cut off currents. To prevent over-current and over-voltage, various protection devices are continuously developed. For example, a device containing a substrate on which a heating layer and a low-melting metal layer are stacked in sequence.

The heating layer heats up in the event of over-voltage, and then the heat is transferred upwards to the low-melting metal layer. As a result, the low-melting metal layer is melted and blown to sever currents flowing therethrough, so as to protect circuits or electronic apparatuses.

Recently, mobile apparatuses such as cellular phones and laptop computers are widely used, and people increasingly rely on such products over time. However, burnout or explosion of batteries of cellular phones or portable products during charging or discharging is often seen. Therefore, the manufacturers continuously improve the designs of over-current and over-voltage protection devices to prevent the batteries from being blown due to over-current or over-voltage during charging or discharging.

In a know protection device, the low-melting metal layer is in series connection to a power line of a battery, and the low-melting metal layer and a heating layer are electrically coupled to a switch and an integrated circuit (IC) device. When the IC device detects an over-voltage event, the IC device enables the switch to “on”. As a result, current flows through the heating layer to generate heat to melt and blow the low-melting metal layer, so as to sever the power line to the battery for over-voltage protection. Moreover, it can be easily understood that the low-melting metal layer, e.g., fuses, can be heated and blown by a large amount of current in the event of over-current, and therefore over-current protection can be achieved also.

The low-melting metal layer of the protection device usually uses lead-containing solder of a melting temperature larger than 300° C. so as not to be blown during a high-temperature reflow process. However, the lead-containing solder is restricted in Restriction of Hazardous Substances (RoHS) Directive. It is a challenge to proceed with reflow for a fusible element having a lower melting temperature.

### SUMMARY OF THE INVENTION

The present application provides a protection device and a circuit protection apparatus containing the same for over-current, over-voltage and/or over-temperature protection. The fusible element of the protection device comprises inner and outer metal layers of different melting temperatures to withstand the melting of the inner metal layer during a sequential high-temperature reflow process.

In accordance with a first aspect of the present application, a protection device comprises a substrate, a fusible element and a heating element. The substrate has a surface provided with a first electrode and a second electrode. The fusible element comprises a first metal layer and a second metal layer disposed on the first metal layer. The melting temperature of the second metal layer is higher than that of the first metal layer. The fusible element connects to the first and second electrodes by solder. The solder has a melting temperature lower than that of the first metal layer. The heating element heats up to blow the fusible element in the event of over-voltage or over-temperature.

In an embodiment, the second metal layer has a melting temperature higher than a temperature during reflow performed afterwards.

In an embodiment, the second metal layer restrain the first metal layer from flowing during reflow.

In an embodiment, the first metal layer comprises tin and alloy thereof.

In an embodiment, the second metal layer comprises silver, copper, gold, nickel, zinc and alloy thereof.

In an embodiment, the first metal layer has a thickness of 0.02-0.3 mm, and the second metal layer has a thickness of 0.002-0.01 mm.

In an embodiment, a thickness of the first metal layer is 10-150 times that of the second metal layer.

In an embodiment, a volume of the first metal layer is larger than that of the second metal layer.

In an embodiment, the heating element comprises ruthenium oxide and additives of silver, palladium or platinum.

In an embodiment, the protection device has an equivalent circuit in which the fusible element comprises two fuses, and the heating element comprises a heater, e.g., a resistor.

In accordance with a second aspect of the present application, a circuit protection apparatus comprises the aforementioned protection device associated with a detector and a switch. The detector is adapted to detect voltage drops or temperatures of a circuit to be protected, and the switch is coupled to the detector to receive its sensing signals. When a voltage drop or a temperature exceeds a threshold value, the switch turns on to allow current to flow through the heating element by which the heating element heats up to melt and blow the fusible element.

The fusible element of the protection device is a composite structure comprising, for example, inner and outer metal layers. The outer metal layer has a melting temperature higher than that of the inner metal layer and may be further higher than the temperature of a sequential reflow process. Accordingly, even if a reflow temperature is higher than the melting temperature of the inner metal layer, the inner metal layer is restrained by the outer metal layer during reflow so as not to flow randomly or deform significantly. Thus, a fusible element having an inner metal layer of a low melting temperature still can withstand high-temperature influence during reflow.

### BRIEF DESCRIPTION OF THE DRAWINGS

The present application will be described according to the appended drawings in which:

FIG. 1 shows a protection device in accordance with an embodiment of the present application;

FIG. 2 shows an equivalent circuit diagram of the protection device of FIG. 1;

FIGS. 3-5 show fusible elements in accordance with some embodiments of the present application; and

FIG. 6 shows a circuit diagram of a circuit protection apparatus in accordance with an embodiment of the present application.

### DETAILED DESCRIPTION OF THE INVENTION

The making and using of the presently preferred illustrative embodiments are discussed in detail below. It should be appreciated, however, that the present application provides many applicable inventive concepts that can be embodied in a wide variety of specific contexts. The specific illustrative embodiments discussed are merely illustrative of specific ways to make and use the invention, and do not limit the scope of the invention.

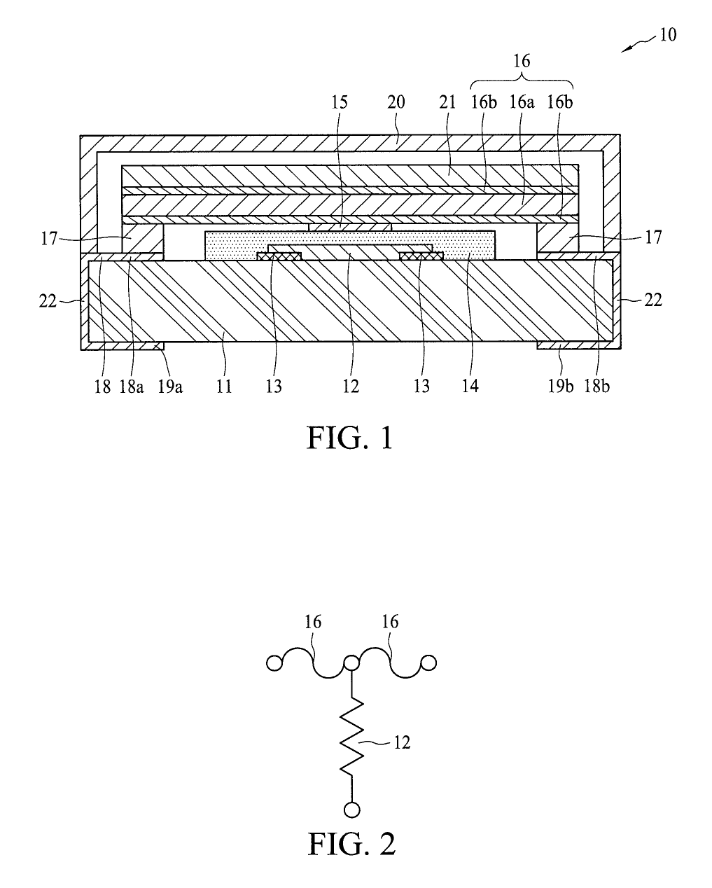

FIG. 1 shows a protection device 10 in accordance with an embodiment of the present application. The protection device 10 comprises a substrate 11, a heating element 12, heating element electrodes 13, an insulating layer 14, an intermediate electrode 15, a fusible element 16, solders 17, an electrode layer 18, lower electrodes 19a and 19b and a housing 20. The rim of the housing 20 is placed on the substrate 11 to form a space to receive the heating element 12 and the fusible element 16. The substrate 11 is usually a planar insulating substrate. The heating element 12 is disposed on the substrate 11 and connect to the heat element electrodes 13 at two ends. The fusible element 16 electrically connects to a first electrode 18a and a second electrode 18b of the electrode layer 18, and a center of the fusible element 16 connects to the intermediate electrode 15 disposed on the insulating layer 14. The fusible element 16 connects to the first electrode 18a and the second electrode 18b at two ends through solders 17. The first electrode 18a and the second electrode 18b connects to the lower left electrode 19a and lower right electrode 19b respectively through conductive members 22 on the sidewalls of the substrate 11. The lower electrodes 19a and 19b serve as interfaces for surface-mounting onto a circuit board. The insulating layer 14 covers the heating element 12 and the heating element electrodes 13. The fusible element 16 is disposed above the insulating layer 14 and serve as fuses in a circuit. The fusible element 16 is a composite structure comprising a first metal layer 16a and a second metal layer 16b disposed on the first metal layer 16a. A flux 21 may be fully or partially daubed on the fusible element 16 to prevent oxidation of the first metal layer 16a and the second metal layer 16b. The flux 21 can form an anti-oxidation layer on the second metal layer 16b to avoid oxidation of the second metal layer so as to sustain blowing efficiency. When over-voltage or over-temperature occurs, the heating element 12 heats up and generated heat is transferred to the fusible element 16. The fusible element 16 is melted and the molten fusible element flows to the first electrode 18a, the second electrode 18b and the intermediate electrode 15, and as a result the fusible element 16 is blown to sever the current for protection to the circuit. FIG. 2 is an equivalent circuit diagram of the protection device 10 of FIG. 1, by virtue of the intermediate electrode 15, the fusible element 16 is devised to comprise two fuses which will be blown by the heat from the heating element 12 as mentioned above in the event of over-voltage or over-temperature.

In an embodiment, the substrate 11 may be a rectangular insulating substrate including aluminum oxide, aluminum nitride, zirconium oxide, glass, or ceramic, or may use the material for printed circuit layout such as glass epoxy substrate or phenolic substrate. The substrate 11 has a thickness of about 0.1-2 mm. The electrode layer 18, the heating element electrodes 13 and the intermediate electrode 15 may comprise silver, gold, copper, tin, nickel or other conductive metals, and its thickness is approximately 0.005-1 mm, or 0.01 mm, 0.05 mm, 0.1 mm, 0.3 mm or 0.5 mm in particular. In addition to making the electrodes by printing, they may be alternatively made of metal sheets for high-voltage applications.

The fusible element 16 is a composite structure comprising inner and outer layers, and may be in the shape of a rectangular bar or a round bar. The first metal layer 16a is the inner layer of a lower melting temperature, and the second metal layer 16b is the outer layer of a higher melting temperature. In other words, the second metal layer 16b has a higher melting temperature than that of the first metal layer 16a. The second metal layer 16b can be formed on the first metal layer 16a by electroplating, vapor deposition, sputtering, attachment or extrusion. The first metal layer 16a may comprise tin or its alloy such as Sn, Sn—Ag, Sn—Sb, Sn—Zn, Sn—Ag—Cu, Pb—Sn—Ag, Sn—Zn—Cu, Sn—Bi—Ag and Sn—Bi—Ag—Cu. In the present application, it is preferable to use but not limited to the lead-free materials to comply with RoHS Directive. The second metal layer 16b may comprise silver, copper, gold, nickel, zinc, or alloys thereof. In addition to a higher melting temperature of the second metal layer 16b compared to the first metal layer 16a, the melting temperature of the second metal layer 16b is higher than reflow temperature. As a result, the outer second metal layer 16b restrains the first metal layer 16a laminated or enclosed by the second metal layer 16b from flowing. Therefore, the fusible element 16 is not blown even if the reflow temperature is higher than the melting temperature of the first metal layer 16a. An anti-oxidation layer comprising, for example, tin may be formed on the second metal layer 16b, and as a consequence the second metal layer 16b which may comprise copper is not oxidized so as to prevent the increase of blowing time if oxidized. It is advantageous to avoid oxidation if the second metal layer 16b comprises silver, but it is costly. The heating element 12 may comprise ruthenium oxide (RuO₂) with additives of silver (Ag), palladium (Pd), and/or platinum (Pt). The insulating layer 14 between the heating element 12 and the fusible element 16 may contain glass, epoxy, aluminum oxide, silicone or glaze.

In an embodiment, the fusible element 16 has a thickness of about 0.05-0.4 mm in which the first metal layer 16a is about 0.02-0.3 mm and the second metal layer 16b (a single layer) is about 0.002-0.01 mm. The first metal layer 16a is thicker than the second metal layer 16b of a single layer. For example, the thickness of the first metal layer 16a is 10-150 times, e.g., 20 times, 50 times, or 100 times, the thickness of the second metal layer 16b of a single layer. If more than 150 times, that is, the first metal layer 16a is much thicker than the second metal layer 16b, the thin second metal layer 16b would be eroded by molten first metal layer 16a and so as not to sustain its shape. The volume of the first metal layer 16a is larger than that of the second metal layer 16b. The molten first metal layer 16a of a large volume can erode the second metal layer 16b efficiently to ensure that the fusible element 16 can be blown timely. In summary, there are adequate ratios in terms of volumes and thicknesses of the first metal layers 16a compared to the second metal layer 16b. The second metal layer 16b of a small thickness or volume has a risk of being eroded by molten first metal layer 16a during reflow, whereas the second metal layer 16b of a large thickness or volume may postpone the blowout timing of the fusible element 16.

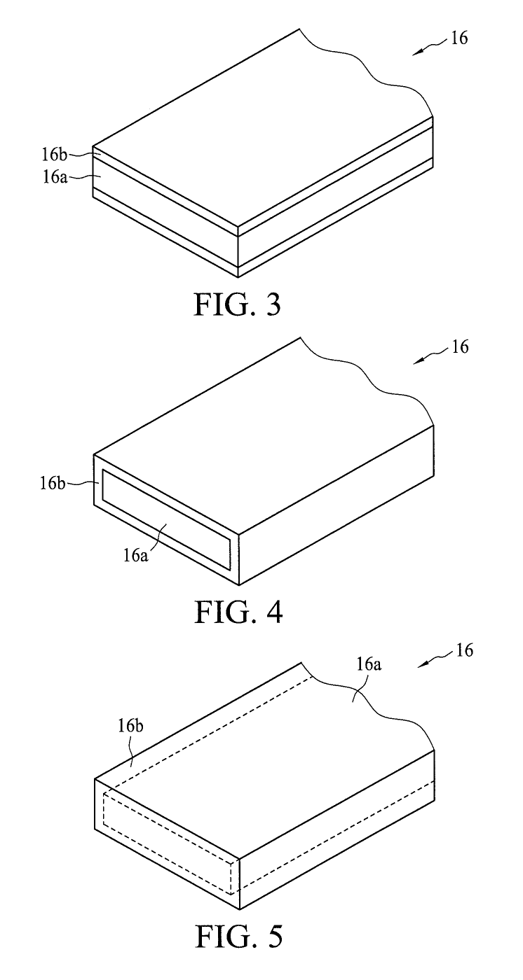

FIG. 3, FIG. 4 and FIG. 5 show fusible elements 16 in accordance with different embodiments. In FIG. 3, the second metal layers 16b are disposed on upper and lower surfaces of the first metal layer 16a. In FIG. 4, the second metal layer 16b encloses the first metal layer 16a except two opposite ends. In FIG. 5, the second metal layer 16b fully encloses the first metal layer 16a. The better enclosure increases capability to resist deformation during melting of the fusible element 16. During reflow of the protection device 10, if a reflow temperature exceeds the melting temperature of the first metal layer 16a, the second metal layer 16b restrains the first metal layer 16a from flowing because the first metal layer 16a is laminated or enclosed by the second metal layer 16b. As a result, the entire fusible element 16 is not molten or flowed to be open-circuit.

Table 1 shows test result of surface temperatures and blowing currents in accordance with exemplary embodiments E1 and E2 of the present application and comparative examples C1 and C2. The surface temperatures are the temperatures of the surface of the fusible element 16 measured by a thermal couple. In E1 and E2, the second metal layers 16b are disposed on upper and lower surfaces of the first metal layer 16a as shown in FIG. 3. The first metal layer 16a comprises Sn and Pb95.5-Sn2-Ag2.5 with melting temperatures or melting points (m.p.) of 232° C. and 308° C., respectively. The second metal layer 16b comprises silver (Ag). The thickness of the fusible element 16 of E1 or E2 is 0.09 mm. The fusible element 16 of C1 and C2 comprise a first metal layer 16a, excluding the second metal layer, and the thickness is 0.08 mm. In other words, the first metal layer 16a has a thickness of 0.08 mm for E1, E2, C1 and C2, and C1 and C2 further comprise upper and lower second metal layers 16b of a thickness of 0.005 mm. E1 and C1 have the first metal layer 16a of the same material, and E1 further comprises the second metal layers 16b and therefore E1 has a lower resistance. As a result, the surface temperature of E1 is lower than that of C1 by 20-40° C. and the blowing current of E1 is larger than that of C1 by 2-4A in the tests subjected to a current of 20A and 30A. Similarly, E2 and C2 have the first metal layer 16a of the same material, E2 further comprises the second metal layers 16b and therefore E2 has a lower resistance. The surface temperature of E2 is lower than that of C2 by 15-30° C. and the blowing current of E2 is larger than that of C2 by 2-3A in the tests subjected to a current of 20A and 30A.

TABLE 1

| | | | Second metal | | Surface | Surface | Blowing |
|---|---|---|---|---|---|---|---|
| | | m.p. | layer | Thickness | temperature | temperature | current |
| | First metal layer | (° C.) | (Ag) | (mm) | (° C. @20 A) | (° C. @30 A) | (A) |
| E1 | Sn | 232 | V | 0.09 | 50~60 | 105~110 | 39-40 |
| E2 | Pb95.5—Sn2—Ag2.5 | 308 | V | 0.09 | 80~90 | 145~160 | 36-37 |
| C1 | Sn | 232 | — | 0.08 | 70~80 | 130~150 | 36-38 |
| C2 | Pb95.5—Sn2—Ag2.5 | 308 | — | 0.08 | 105~120 | 160~180 | 34-35 |

In E1 and C1, the solder 17 for soldering the fusible element 16 onto the electrode layer 18 is Sn—Cu0.7 of which a melting point 227° C. is lower than the melting point 232° C. of the first metal layer 16a. The solder 17 of E2 and C2 is Pb—Sn2-Ag2.5 of which a melting point 268 ° C. is lower than the melting point 308° C. of the first metal layer 16a. Alternatively, the solder 17 may comprise Sn—Ag3-Cu0.7 (m.p. 217° C.), Sn—Ag0.3-Cu0.7 (m.p. 217° C.) or Sn—Bi—Ag (m.p. 262° C.) according to melting temperature requirement. Preferably, the melting temperature of the solder 17 is lower than that of the inner first metal layer 16a. There are more low melting temperature solders in the market to be selected, and the fusible element 16 can be soldered at a lower reflow temperature. When soldering the protection device 10 onto a circuit board, the solder 17 between the substrate 11 and the fusible element 16 is not affected by a mechanical force and therefore it does not flow or deform severely even if the process temperature is higher than the melting temperature of the solder 17.

In summary, the fusible element 16 comprising an inner first metal layer 16a and an outer second metal layer 16b has a lower surface temperature and a larger blowing current compared to a known fusible element of a single metal layer. The solder 17 connecting the fusible element 16 and the electrode layer 18 has a lower melting temperature than that of the first metal layer 16a such that more solder products can be selected in the market and a reflow process of a low temperature can be employed.

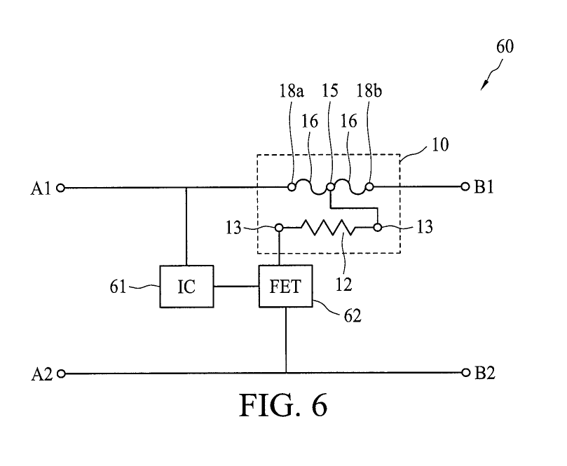

The equivalent circuit diagram of the protection device 10 of this embodiment is depicted in a dashed-line block in FIG. 6. The first electrode 18a connects to a terminal A1 of an apparatus to be protected such as a secondary battery or a motor, whereas the second electrode 18b connects to a terminal B1 of a charger or the like. The intermediate electrode 15 connects to a heating element electrode 13 and another heating element electrode 13 connects to a switch 62. According to this circuit design of the protection device 10, the fusible element 16 forms a circuit containing two fuses in series connection, and the heating element 12 forms a heater denoted by a resistor. In an embodiment, the switch 62 may be a field-effect transistor (FET). The gate electrode of the switch 62 connects to a detector 61, and the switch 62 connects to a terminal A2 of the apparatus to be protected and a terminal B2 of the charger. The detector 61 may be an IC device capable of sensing voltage drops and temperatures of the circuit. If no over-voltage and over-temperature event, the switch 62 is off, current flows through fusible element 16 and no current flows through the heating element 12. If over-current occurs, the fusible element 16 is blown to provide over-current protection. When the detector 61 senses a voltage or a temperature larger than a threshold value, i.e., over-voltage or over-temperature, the switch 62 turns on to allow current to flow through the source and drain electrodes of the switch 62 and the heating element 12, and accordingly the heating element 12 heats up to blow the fusible element 16 to provide over-voltage and over-temperature protections. In summary, two power lines of B1 to A1 and B2 to A2 supply power to the circuit to be protected. The protection device 10, the detector 61 and the switch 62 are coupled to the two power lines to form a circuit protection apparatus 60. If the detector 61 senses a voltage drop or a temperature over a threshold value, then the heating element 12 is activated to blow the fusible element 16.

The equivalent circuit diagrams of the protection devices of the aforesaid embodiments comprise two fuses and a heater. Nevertheless, variant designs in terms of structure or circuit may be used to form a protection device containing two fuses and two heaters, or one fuse and one heater, which are also covered by the scope of the present application. In an embodiment, the fusible element may electrically connect to two bonding pads to form a current path and the heating element electrically connect to another two bonding pads to form another current path, so as to independently control the current flowing through the heating element to blow the fusible element.

The protection device of the present application comprises a composite fusible element having a first metal layer of a low melting temperature and a second metal layer of a high melting temperature. As a result, the first metal layer of a low melting temperature can serve as a main part of the fusible element and is still able to prevent the blowout of the fusible element during sequential high-temperature processes. The fusible element of the present application has better heat dissipation efficiency, thereby decreasing the surface temperature of the protection device by 20-40% and increasing the blowing current of the fusible element. The metal layer of a low melting temperature is used as a main part of the fusible element in which lead-free material is preferably employed to comply with RoHS Directive though lead-containing material is not excluded in the present application.

The above-described embodiments of the present invention are intended to be illustrative only. Numerous alternative embodiments may be devised by persons skilled in the art without departing from the scope of the following claims.

1. A protection device, comprising:
a substrate having a surface provided with a first electrode and a second electrode;
a fusible element comprising a first metal layer and a second metal layer, the second metal layer being disposed on the first metal layer, the second metal layer having a melting temperature higher than that of the first metal layer, the first metal layer being an inner layer of the fusible element, the second metal layer being an outer layer of the fusible element; and
a heating element which heats up to blow the fusible element in the event of over-voltage or over-temperature;
wherein the second metal layer of the fusible element connects to the first electrode and the second electrode through solder, and the solder has a melting temperature lower than that of the first metal layer.

2. The protection device of claim 1, wherein the melting temperature of the second metal layer is higher than a temperature during reflow performed afterwards.

3. The protection device of claim 2, wherein the second metal layer restrains the first metal layer from flowing during reflow.

4. The protection device of claim 1, wherein the first metal layer comprises tin or alloys thereof.

5. The protection device of claim 1, wherein the second metal layer comprises silver, copper, gold, nickel, zinc or alloys thereof.

6. The protection device of claim 1, wherein the first metal layer has a thickness of 0.02-0.3 mm, and the second metal layer has a thickness of 0.002-0.01 mm.

7. The protection device of claim 1, wherein a thickness of the first metal layer is 10-150 times that of the second metal layer.

8. The protection device of claim 1, wherein a volume of the first metal layer is larger than that of the second metal layer.

9. The protection device of claim 1, wherein the heating element comprises ruthenium oxide and additives of silver, palladium or platinum.

10. The protection device of claim 1, wherein the fusible element comprises two fuses, and the heating element comprises a heater.

11. A circuit protection apparatus, comprising:
a protection device, comprising:
a substrate having a surface provide with a first electrode and a second electrode;
a fusible element comprising a first metal layer and a second metal layer, the second metal layer being disposed on the first metal layer, the second metal layer having a melting temperature higher than that of the first metal layer the first metal layer being an inner layer of the fusible element, the second metal layer being an outer layer of the fusible element; and
a heating element; and
a detector that senses a voltage drop or a temperature of a circuit to be protected; and
a switch coupled to the detector to receive signals of the detector;
wherein the second metal layer of the fusible element connects to the first electrode and the second electrode through solder, and the solder has a melting temperature lower than that of the first metal layer;
wherein the switch turns on to allow current to flow through the heating element by which the heating element heats up to blow the fusible element when the detector senses the voltage drop or the temperature exceeding a threshold value.

12. The circuit protection apparatus of claim 11, wherein the melting temperature of the second metal layer is higher than a temperature during reflow performed afterwards.

13. The circuit protection apparatus of claim 11, wherein the first metal layer comprises tin or alloys thereof.

14. The circuit protection apparatus of claim 11, wherein the second metal layer comprises silver, copper, gold, nickel, zinc or alloys thereof.

15. The circuit protection apparatus of claim 11, wherein the second metal layer restrains the first metal layer from flowing during reflow.
